(19) United States
(12) Patent Application Publication
(10) Pub. No.: US 2009/0141013 A1
(43) Pub. Date: Jun. 4, 2009

(54) Display Device and Drive Method Thereof

(76) Inventors: Tomoyuki Nagai, Mie (JP); Hajime Washio, Oxford (GB)

Correspondence Address: HARNESS, DICKEY & PIERCE, P.L.C., P.O. BOX 8910, RESTON, VA, 20195, US

(21) Appl. No.: 12/085,189

(22) PCT Filed: Dec. 15, 2006
(86) PCT No.: PCT/JP2006/325025

§ 371 Date: Aug. 13, 2008

(30) Foreign Application Priority Data
Dec. 15, 2005 (JP) 2005-361295

(51) Int. Cl. G09G 5/00

(52) U.S. Cl. 345/211

(57) ABSTRACT

The present invention relates to a display device and a drive method thereof.

An object of the present invention is to provide a display device capable of performing multi-gray scale display with a simple circuit design, without a display image becoming coarse.

A pixel circuit of a display device includes a pixel memory (50) capable of storing 1-bit data. When switching is performed from normal display to memory drive, binarized data for image display during a memory drive period is stored in the pixel memory (50). A first supply voltage (VAL) and a second supply voltage (VBL) are provided to the pixel circuit and the voltage values thereof change by a duty ratio set by a memory drive control unit (20). Upon memory drive, according to the data stored in the pixel memory (50), a voltage is applied to a liquid crystal capacitance (51) which is a display medium, based on one of the first supply voltage (VAL) and the second supply voltage (VBL), whereby image display is performed.

### TECHNICAL FIELD

The present invention relates to a display device, and more particularly to a display device including a pixel circuit having a memory function and a drive method thereof.

### BACKGROUND ART

In a liquid crystal display device, there has thus far been a demand for a reduction in power consumption. To reduce power consumption, when a screen display with little image change, such as display of time, is performed in a mobile phone, for example, a process of extending a period during which a video signal is written to a liquid crystal capacitance in an image formation portion for displaying a pixel is performed. However, when a period during which a video signal is written to a liquid crystal capacitance is extended, an applied voltage needs to be held in the liquid crystal capacitance for a long period of time. Therefore, in a liquid crystal display device such as the one described above, in order that a voltage applied to a liquid crystal capacitance is held, a memory (hereinafter, referred to as a “pixel memory”) is provided in each pixel formation portion.

By the way, in general, data (hereinafter, referred to as “in-memory data”) to be stored in the above-described pixel memory is one bit. Hence, with one pixel, only 2-gray scale display can be performed. In view of this, to implement multi-gray scale display, a display method called an area ratio gray scale method has been proposed.

FIG. 13 is a diagram for describing an area ratio gray scale method. Generally, in a color liquid crystal display device, a pixel is formed of three sub-pixels for R (Red), G (Green), and B (Blue). In a color liquid crystal display device that adopts an area ratio gray scale method, as shown in FIG. 13A, each sub-pixel is divided into two pixels (hereinafter, referred to as “divided sub-pixels”) 91 and 92 having different sizes. Then, based on 2-bit data, control of turning on/off of two divided sub-pixels 91 and 92 included in one sub-pixel is performed.

When the above-described 2-bit data is represented by (X·Y) (the value that both “X” and “Y” can take is “0” or “1”), control of turning on/off is performed in the manner shown below, for example. When the 2-bit data is (1·1), both a divided sub-pixel 91 which is the bigger one and a divided sub-pixel 92 which is the smaller one are turned on. When the 2-bit data is (1·0), only the divided sub-pixel 91 which is the bigger one is turned on. When the 2-bit data is (0·1), only the divided sub-pixel 92 which is the smaller one is turned on. When the 2-bit data is (0·0), neither of the divided sub-pixels 91 and 92 is turned on. In the above-described manner, with one sub-pixel, 4-gray scale display is performed.

As a method for implementing multi-gray scale display, a display method called a voltage gray scale method is also known. In a liquid crystal display device that adopts a voltage gray scale method, a plurality of power supply lines that supply voltages of different voltage values are provided according to the number of gray scales required for display. Then, display of each pixel is performed based on a voltage supplied from any of the plurality of power supply lines.

[Patent Document 1] Japanese Patent Application Laid-Open No. 2004-86153

### DISCLOSURE OF THE INVENTION

### Problems to be Solved by the Invention

However, in a liquid crystal display device that adopts an area ratio gray scale method, when an oblique line is displayed on a display unit, for example, as shown in FIG. 13B, an image (display image) to be displayed may become coarse. An event that a display image thus becomes coarse will be described below with reference to FIG. 13C. FIG. 13C is an enlarged diagram of a portion indicated by reference numeral 90 in FIG. 13B. Here, it is assumed that 2-bit data (0·1) is provided to a sub-pixel indicated by reference numeral 93 and a sub-pixel indicated by reference numeral 94 and 2-bit data (0·0) is provided to other sub-pixels. Therefore, as shown in FIG. 13C, only the smaller divided-sub pixel of the sub-pixel indicated by reference numeral 93 and the smaller divided-sub pixel of the sub-pixel indicated by reference numeral 94 are turned on. As a result, as shown in FIG. 13B, when looking at the entire display unit, the display image looks coarse.

On the other hand, in a liquid crystal display device that adopts a voltage gray scale method, since a sub-pixel is not divided, a problem that a display image looks coarse does not occur. However, as the number of gray scales required for display increases, the number of required power supply lines increases, complicating a circuit design.

In view of this, an object of the present invention is to provide a display device capable of performing multi-gray scale display with a simple circuit design, without a display image becoming coarse.

### Means for Solving the Problems

A first aspect of the present invention is a display device having a first display mode and a second display mode, the display device including:

a plurality of video signal lines for transmitting a video signal which is based on an image to be displayed;

a plurality of scanning signal lines intersecting the plurality of video signal lines;

a plurality of pixel formation portions arranged in a matrix so as to correspond to intersections of the plurality of video signal lines and the plurality of scanning signal lines, each pixel formation portion including a first electrode and a second electrode which sandwich a display medium for forming the image to be displayed;

a plurality of storage circuits provided for the respective plurality of pixel formation portions, each storage circuit capturing and storing binary data which is based on the video signal transmitted by a video signal line passing through a corresponding intersection, when switching is performed from the first display mode to the second display mode;

a duty ratio setting circuit that sets a first duty ratio and a second duty ratio according to the image to be displayed;

a supply voltage generation circuit that generates a first supply voltage having a pulse width which is based on the first duty ratio and a second supply voltage having a pulse width which is based on the second duty ratio;

a plurality of first voltage supply lines provided for the respective plurality of scanning signal lines and transmitting the first supply voltage;

a plurality of second voltage supply lines provided for the respective plurality of scanning signal lines and transmitting the second supply voltage; and

a plurality of selection circuits provided for the respective plurality of pixel formation portions, each selection circuit applying, in the second display mode, one of the first supply voltage and the second supply voltage to the first electrode provided in a corresponding pixel formation portion, according to a value of the binary data stored in a corresponding storage circuit, the first supply voltage being transmitted by the first voltage supply line provided for a scanning signal line passing through a corresponding intersection and the second supply voltage being transmitted by the second voltage supply line provided for the scanning signal line passing through the corresponding intersection.

A second aspect of the present invention is the display device according to the first aspect of the present invention, wherein

the first voltage supply lines include first voltage supply lines for a first color, a second color, and a third color,

the second voltage supply lines include second voltage supply lines for the first color, the second color, and the third color, and

the duty ratio setting circuit

sets the first duty ratio for each of the first voltage supply lines for the first color, the second color, and the third color, and

sets the second duty ratio for each of the second voltage supply lines for the first color, the second color, and the third color.

A third aspect of the present invention is the display device according to the first aspect of the present invention, wherein the duty ratio setting circuit temporally changes the first duty ratio and the second duty ratio according to the image to be displayed.

A fourth aspect of the present invention is the display device according to the first aspect of the present invention, wherein

a predetermined first potential and a predetermined second potential are alternately provided to the second electrodes at predetermined intervals, and

the duty ratio setting circuit

changes the first duty ratio such that a first value and a second value whose sum is 100% are alternately set at the predetermined intervals as the first duty ratio, and

changes the second duty ratio such that a third value and a fourth value whose sum is 100% are alternately set at the predetermined intervals as the second duty ratio.

A fifth aspect of the present invention is a drive method for a display device having a first display mode and a second display mode, the display device including: a plurality of video signal lines for transmitting a video signal which is based on an image to be displayed; a plurality of scanning signal lines intersecting the plurality of video signal lines; a plurality of pixel formation portions arranged in a matrix so as to correspond to intersections of the plurality of video signal lines and the plurality of scanning signal lines, each pixel formation portion including a first electrode and a second electrode which sandwich a display medium for forming the image to be displayed; a plurality of storage circuits provided for the respective plurality of pixel formation portions; a plurality of first voltage supply lines provided for the respective plurality of scanning signal lines; a plurality of second voltage supply lines provided for the respective plurality of scanning signal lines; and a supply voltage generation circuit that generates a first supply voltage to be applied to the plurality of first voltage supply lines and a second supply voltage to be applied to the plurality of second voltage supply lines, the drive method including:

a display mode switching step of switching from the first display mode to the second display mode by capturing and storing, in each storage circuit, binary data which is based on the video signal transmitted by a video signal line passing through a corresponding intersection;

a duty ratio setting step of setting a first duty ratio for setting a pulse width of the first supply voltage and a second duty ratio for setting a pulse width of the second supply voltage, based on the image to be displayed; and

a second display mode displaying step of applying, in each pixel formation portion, one of the first supply voltage and the second supply voltage to the first electrode, according to a value of the binary data stored in a corresponding storage circuit, the first supply voltage being transmitted by the first voltage supply line provided for a scanning signal line passing through a corresponding intersection and having a pulse width which is based on the first duty ratio, and the second supply voltage being transmitted by the second voltage supply line provided for the scanning signal line passing through the corresponding intersection and having a pulse width which is based on the second duty ratio.

A sixths aspect of the present invention is the drive method according to the fifth aspect of the present invention, wherein in the duty ratio setting step, the first duty ratio and the second duty ratio are temporally changed according to the image to be displayed.

A seventh aspect of the present invention is the drive method according to the fifth aspect of the present invention, wherein

a predetermined first potential and a predetermined second potential are alternately provided to the second electrodes at predetermined intervals, and

in the duty ratio setting step,

the first duty ratio is changed such that a first value and a second value whose sum is 100% are alternately set at the predetermined intervals as the first duty ratio, and

the second duty ratio is changed such that a third value and a fourth value whose sum is 100% are alternately set at the predetermined intervals as the second duty ratio.

### EFFECT OF THE INVENTION

According to the first aspect of the present invention, a storage circuit that stores binary data is provided for each pixel formation portion. In the storage circuit, when switching is performed from a first display mode to a second display mode, binary data which is based on a video signal transmitted by a video signal line passing through a corresponding intersection is stored. In addition, in the display device, there are provided first voltage supply lines that transmit a first supply voltage with a pulse width which is based on a first duty ratio and second voltage supply lines that transmit a second supply voltage with a pulse width which is based on a second duty ratio. Then, in the second display mode, in each pixel, according to the value of binary data, image display which is based on a voltage transmitted by one of a first voltage supply line and a corresponding second voltage supply line is performed. Hence, in the second display mode, there is no need to supply a video signal to the pixel formation portions. Accordingly, for example, by displaying a standby screen of a mobile phone using the second display mode, during a period in which image display is performed in the second display mode, a video signal having a high frequency is not necessary, whereby the power consumed in the display device is reduced. In addition, since the first duty ratio and the second duty ratio are set according to an image to be displayed, multi-gray scale image display is enabled in each pixel. Moreover, by setting various values for the first duty ratio and the second duty ratio, the voltage value of the first supply voltage and the voltage value of the second supply voltage become various values. Accordingly, the number of gray scales of a display image can be increased without increasing the number of voltage supply lines. Therefore, multi-gray scale image display is implemented without complicating the circuit configuration.

According to the second aspect of the present invention, the first duty ratio and the second duty ratio can be set on a color-by-color basis. Thus, voltages of different potentials for different colors can be applied to a first electrode in each pixel formation portion, whereby multi-gray scale image display is easily implemented.

According to the third aspect of the present invention, the first duty ratio and the second duty ratio are temporally changed according to an image to be displayed. Therefore, voltages of various voltage values are applied to a first electrode in each pixel formation portion. Thus, multi-gray scale image display is temporally enabled in each pixel.

According to the fourth aspect of the present invention, a voltage applied to a display medium can be inverted at predetermined time intervals. Hence, alternating current drive is performed in the display device. Therefore, while preventing the deterioration of the display medium resulting from the application of a direct-current voltage, multi-gray scale image display is implemented.

### BRIEF DESCRIPTION OF THE DRAWINGS

FIG. 1 is an equivalent circuit diagram showing the configuration of a pixel circuit of one sub-pixel in a liquid crystal display device according to a first embodiment of the present invention.

FIG. 2 is a block diagram showing the overall configuration of the liquid crystal display device in the first embodiment.

FIG. 3 is a schematic diagram for describing connection relationships between pixels and first voltage supply lines, second voltage supply lines, etc., in the first embodiment.

FIGS. 4A to 4H are signal waveform diagrams for describing a drive method in the first embodiment.

FIGS. 5A to 5D are signal waveform diagrams for when black display is performed upon memory drive in the first embodiment.

FIGS. 6A to 6D are signal waveform diagrams for when white display is performed upon memory drive in the first embodiment.

FIG. 7 is a signal waveform diagram for describing half-tone display in the first embodiment.

FIGS. 8A to 8C are signal waveform diagrams showing an example for when half-tone display is performed in the first embodiment.

FIGS. 9A to 9C are signal waveform diagrams showing another example for when half-tone display is performed in the first embodiment.

FIG. 10 is a block diagram showing the overall configuration of a liquid crystal display device according to a second embodiment of the present invention.

FIG. 11 is an equivalent circuit diagram showing the configuration of a pixel circuit of one sub-pixel in the second embodiment.

FIGS. 12A to 12L are signal waveform diagrams for describing a drive method in the second embodiment.

FIGS. 13A to 13C are diagrams for describing an area ratio gray scale method.

### DESCRIPTION OF THE REFERENCE NUMERALS

20: MEMORY DRIVE CONTROL UNIT

50 and 60: PIXEL MEMORY

51: LIQUID CRYSTAL CAPACITANCE

52: COMMON ELECTRODE

55: PIXEL ELECTRODE

100: LIQUID CRYSTAL DISPLAY PANEL

200: DISPLAY CONTROL CIRCUIT

300: SOURCE DRIVER

400: GATE DRIVER

410: SUPPLY VOLTAGE GENERATION CIRCUIT

500: DISPLAY UNIT

600: MEMORY DRIVER

AL: FIRST VOLTAGE SUPPLY LINE

BL: SECOND VOLTAGE SUPPLY LINE

GL: GATE BUS LINE

MD: IN-MEMORY DATA

SAL: FIRST SUPPLY VOLTAGE CONTROL SIGNAL

SBL: SECOND SUPPLY VOLTAGE CONTROL SIGNAL

SEL: MEMORY DRIVE SELECTION LINE

SL: SOURCE BUS LINE

SW1 to SW11, SW21 to SW23, and SW25 to SW30: SWITCH

VLCH: FIRST POWER SUPPLY LINE

VLCL: SECOND POWER SUPPLY LINE

### BEST MODE FOR CARRYING OUT THE INVENTION

Embodiments of the present invention will be described below with reference to the accompanying drawings.

### First Embodiment

### <1.1 Overall Configuration and Operation of a Liquid Crystal Display Device>

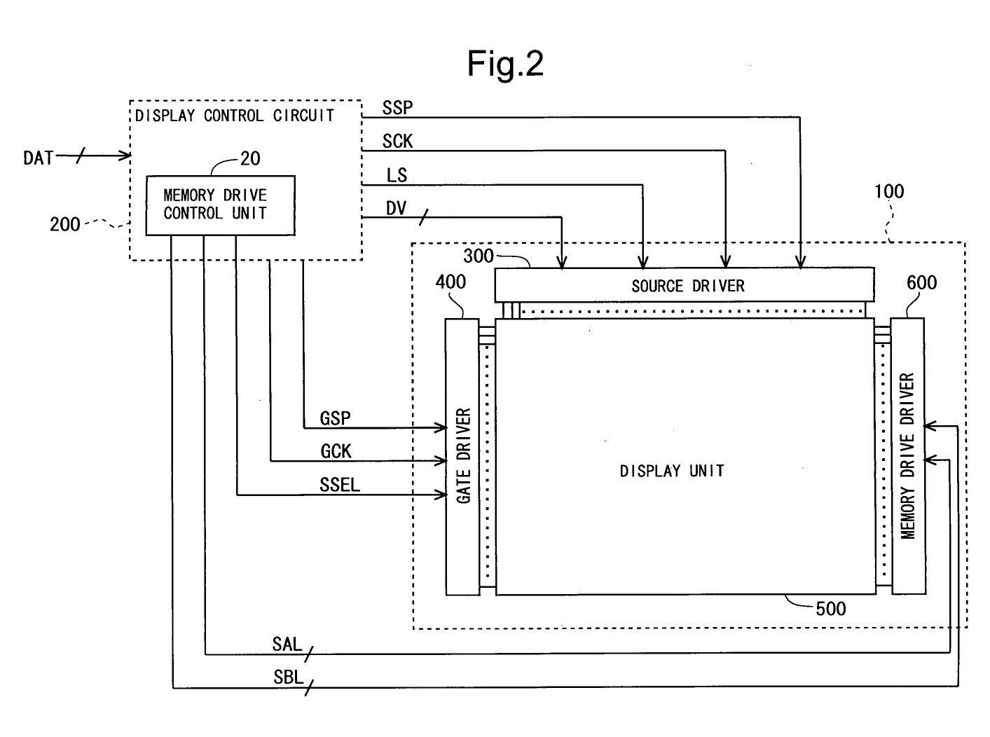

FIG. 2 is a block diagram showing the overall configuration of a liquid crystal display device according to a first embodiment of the present invention. This liquid crystal display device has a liquid crystal display panel 100 and a display control circuit 200. The liquid crystal display panel 100 includes a source driver (video signal line drive circuit) 300, a gate driver (scanning signal line drive circuit) 400, a display unit 500, and a memory driver 600 serving as a supply voltage generation circuit. The display control circuit 200 includes a memory drive control unit 20 serving as a duty ratio setting circuit. The display unit 500 includes source bus lines (video signal lines), gate bus lines (scanning signal lines), memory drive selection lines which will be described later, first voltage supply lines, second voltage supply lines, first power supply lines, and second power supply lines. Note that the source bus lines are connected to the source driver 300, the gate bus lines and the memory drive selection lines are connected to the gate driver 400, and the first voltage supply lines and the second voltage supply lines are connected to the memory driver 600. The display unit 500 also includes a plurality of pixel formation portions respectively provided at intersections of the gate bus lines and the source bus lines. Each pixel formation portion is configured by a pixel electrode serving as a first electrode for applying a voltage according to an image to be displayed to a liquid crystal capacitance which will be described later; a common electrode serving as a second electrode which is a counter electrode provided so as to be shared between the plurality of pixel formation portions; and a liquid crystal layer provided so as to be shared between the plurality of pixel formation portions and sandwiched between the pixel electrode and the common electrode. If necessary, an auxiliary capacitance is added in parallel to a liquid crystal capacitance which is formed by the pixel electrode and the common electrode. In addition, a pixel memory serving as a storage circuit capable of holding 1-bit data is provided for each pixel formation portion. Note that the liquid crystal display device according to the present embodiment is described assuming that the device is of a normally white type.

In the liquid crystal display device according to the present embodiment, a drive method is switched between “normal drive” and “memory drive”. Here, the “normal drive” indicates a drive method which is commonly performed in a liquid crystal display device and in which a write (application of a voltage) to a liquid crystal capacitance is performed based on a video signal applied to each source bus line. On the other hand, the “memory drive” indicates a method in which a write to a liquid crystal capacitance is performed based on data (in-memory data) held in a pixel memory. Note that in the following, a display state for normal drive is referred to as a “first display mode” and a display state for memory drive is referred to as a “second display mode”.

The display control circuit 200 receives image data DAT transmitted from an external source and outputs a digital video signal DV, and a source start pulse signal SSP, a source clock signal SCK, a latch strobe signal LS, a gate start pulse signal GSP, a gate clock signal GCK, a first supply voltage control signal SAL, a second supply voltage control signal SBL, and a memory drive control signal SSEL which are used to control image display on the display unit 500.

The source driver 300 receives the digital video signal DV, the source start pulse signal SSP, the source clock signal SCK, and the latch strobe signal LS which are outputted from the display control circuit 200 and applies a drive video signal to each source bus line.

Upon normal drive, the gate driver 400 repeats, in order to sequentially select each gate bus line every one horizontal scanning period, an application of an active scanning signal to each gate bus line with one vertical scanning period as a cycle, based on the gate start pulse signal GSP and the gate clock signal GCK which are outputted from the display control circuit 200. When switching is performed from normal drive to memory drive, the gate driver 400 sequentially applies, in order to sequentially select each gate bus line every one horizontal scanning period, an active scanning signal to each gate bus line based on the gate start pulse signal GSP and the gate clock signal GCK which are outputted from the display control circuit 200, and also sequentially applies, in order to sequentially select each memory drive selection line every one horizontal scanning period, an active signal to each memory drive selection line based on the memory drive control signal SSEL and the gate clock signal GCK which are outputted from the display control circuit 200. Upon memory drive, the gate driver 400 stops the application of an active scanning signal to each gate bus line and applies an active signal to all memory drive selection lines SEL1 to SELm.

The memory driver 600 applies a voltage signal to the first voltage supply lines and the second voltage supply lines based on the first supply voltage control signal SAL and the second supply voltage control signal SBL which are outputted from the display control circuit 200.

### <1.2 Configuration of a Pixel Circuit>

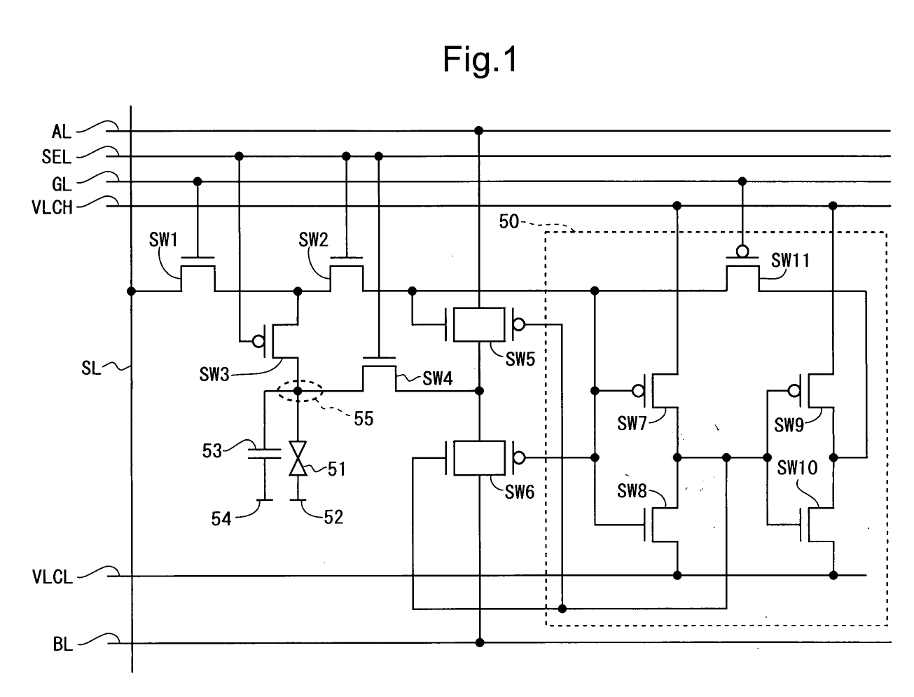

Next, a circuit (hereinafter, referred to as a “pixel circuit”) configuring a pixel formation portion, its corresponding pixel memory, etc., will be described. FIG. 1 is an equivalent circuit diagram showing the configuration of a pixel circuit of one sub-pixel in the present embodiment. The pixel circuit includes CMOS switches SW5 and SW6, each of which is configured by a P-type TFT and an N-type TFT; switches SW1, SW2, SW4, SW8, and SW10, each of which is implemented by an N-type TFT; switches SW3, SW7, SW9, and SW11, each of which is implemented by a P-type TFT; a liquid crystal capacitance 51; and an auxiliary capacitance 53. In the pixel circuit, a pixel memory 50 is configured by an inverter implemented by the switches SW7 and SW8, an inverter implemented by the switches SW9 and SW10, and a transfer gate implemented by the SW11. In addition, in the present embodiment, a selection circuit is implemented by the switches SW5 and SW6. Note that one end of the liquid crystal capacitance 51 and one end of the auxiliary capacitance 53 are connected to a pixel electrode 55. The other end of the liquid crystal capacitance 51 is connected to a common electrode 52 and the other end of the auxiliary capacitance 53 is connected to an auxiliary capacitance electrode 54.

Connection relationships between the switches, etc., are as follows. For the switch SW1, the gate terminal is connected to a gate bus line GL; the source terminal is connected to a source bus line SL; and the drain terminal is connected to the source terminal of the switch SW2 and the source terminal of the switch SW3. For the switch SW2, the gate terminal is connected to a memory drive selection line SEL; the source terminal is connected to the drain terminal of the switch SW1 and the source terminal of the switch SW3; and the drain terminal is connected to the gate terminal of the N-type TFT of the switch SW5, the gate terminal of the P-type TFT of the switch SW6, the gate terminal of the switch SW7, the gate terminal of the switch SW8, and the drain terminal of the switch SW11.

For the switch SW3, the gate terminal is connected to the memory drive selection line SEL; the source terminal is connected to the drain terminal of the switch SW1 and the source terminal of the switch SW2; and the drain terminal is connected to the pixel electrode 55. For the switch SW4, the gate terminal is connected to the memory drive selection line SEL; the source terminal is connected to the output terminal of the switch SW5 and the output terminal of the switch SW6; and the drain terminal is connected to the pixel electrode 55.

For the switch SW5, the input terminal is connected to a first voltage supply line AL; the output terminal is connected to the source terminal of the switch SW4 and the output terminal of the switch SW6; the gate terminal of the N-type TFT is connected to the drain terminal of the switch SW2, the gate terminal of the P-type TFT of the switch SW6, the gate terminal of the switch SW7, the gate terminal of the switch SW8, and the drain terminal of the switch SW11; and the gate terminal of the P-type TFT is connected to the gate terminal of the N-type TFT of the switch SW6, the drain terminal of the switch SW7, the drain terminal of the switch SW8, the gate terminal of the switch SW9, and the gate terminal of the switch SW10. For the switch SW6, the input terminal is connected to a second voltage supply line BL; the output terminal is connected to the source terminal of the switch SW4 and the output terminal of the switch SW5; the gate terminal of the N-type TFT is connected to the gate terminal of the P-type TFT of the switch SW5, the drain terminal of the switch SW7, the drain terminal of the switch SW8, the gate terminal of the switch SW9, and the gate terminal of the switch SW10; and the gate terminal of the P-type TFT is connected to the drain terminal of-the switch SW2, the gate terminal of the N-type TFT of the switch SW5, the gate terminal of the switch SW7, the gate terminal of the switch SW8, and the drain terminal of the switch SW11.

For the switch SW7, the gate terminal is connected to the drain terminal of the switch SW2, the gate terminal of the N-type TFT of the switch SW5, the gate terminal of the P-type TFT of the switch SW6, the gate terminal of the switch SW8, and the drain terminal of the switch SW11; the source terminal is connected to a first power supply line VLCH; and the drain terminal is connected to the gate terminal of the P-type TFT of the switch SW5, the gate terminal of the N-type TFT of the switch SW6, the drain terminal of the switch SW8, the gate terminal of the switch SW9, and the gate terminal of the switch SW10. For the switch SW8, the gate terminal is connected to the drain terminal of the switch SW2, the gate terminal of the N-type TFT of the switch SW5, the gate terminal of the P-type TFT of the switch SW6, the gate terminal of the switch SW7, and the drain terminal of the switch SW11; the source terminal is connected to a second power supply line VLCL; and the drain terminal is connected to the gate terminal of the P-type TFT of the switch SW5, the gate terminal of the N-type TFT of the switch SW6, the drain terminal of the switch SW7, the gate terminal of the switch SW9, and the gate terminal of the switch SW10.

For the switch SW9, the gate terminal is connected to the gate terminal of the P-type TFT of the switch SW5, the gate terminal of the N-type TFT of the switch SW6, the drain terminal of the switch SW7, the drain terminal of the switch SW8, and the gate terminal of the switch SW10; the source terminal is connected to the first power supply line VLCH; and the drain terminal is connected to the source terminal of the switch SW11 and the drain terminal of the switch SW10. For the switch SW10, the gate terminal is connected to the gate terminal of the P-type TFT of the switch SW5, the gate terminal of the N-type TFT of the switch SW6, the drain terminal of the switch SW7, the drain terminal of the switch SW8, and the gate terminal of the switch SW9; the source terminal is connected to the second power supply line VLCL; and the drain terminal is connected to the source terminal of the switch SW11 and the drain terminal of the switch SW9. For the switch SW11, the gate terminal is connected to the gate bus line GL; the source terminal is connected to the drain terminal of the switch SW9 and the drain terminal of the switch SW10; and the drain terminal is connected to the drain terminal of the switch SW2, the gate terminal of the N-type TFT of the switch SW5, the gate terminal of the P-type TFT of the switch SW6, the gate terminal of the switch SW7, and the gate terminal of the switch SW8.

The pixel electrode 55 is connected to the drain terminal of the switch SW3 and the drain terminal of the switch SW4. As described above, the liquid crystal capacitance 51 is formed by the pixel electrode 55 and the common electrode 52, and the auxiliary capacitance 53 is formed by the pixel electrode 55 and the auxiliary capacitance electrode 54.

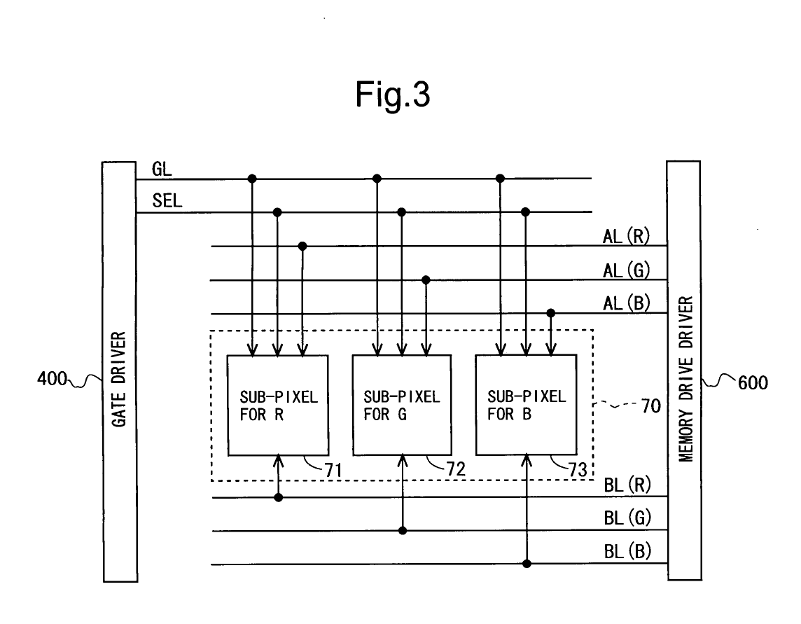

FIG. 3 shows a connection relationship, when looking at a certain pixel 70, between the pixel 70 and a gate bus line GL, a memory drive selection line SEL, first voltage supply lines AL, and second voltage supply lines BL. The pixel 70 is formed of a sub-pixel 71 for R (Red), a sub-pixel 72 for G (Green) and a sub-pixel 73 for B (Blue). The gate bus line GL and the memory drive selection line SEL are connected to the gate driver 400, and the first voltage supply lines AL and the second voltage supply lines BL are connected to the memory driver 600. Here, as shown in FIG. 3, in the present embodiment, a first voltage supply line AL(R) for R (for a first color), a first voltage supply line AL (G) for G (for a second color), and a first voltage supply line AL(B) for B (for a third color) are provided for one gate bus line GL. The same also applies to the second voltage supply lines BL. Namely, in order that different voltages can be applied for different colors, three first voltage supply lines AL and three second voltage supply lines are provided for one gate bus line GL.

### <1.3 Drive Method>

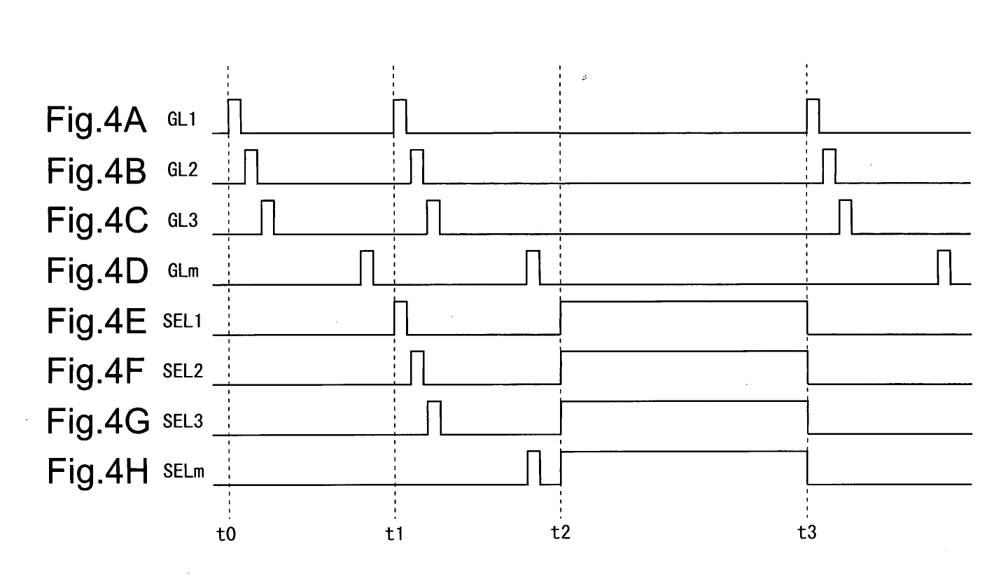

Next, with reference to FIGS. 1 and 4, a drive method in the present embodiment will be described. Note that description is made assuming that the liquid crystal display device according to the present embodiment has m gate bus lines provided therein. FIG. 4 is a signal waveform diagram for the first, second, third, and m-th gate bus lines GL1, GL2, GL3, and GLm, and the first, second, third, and m-th memory drive selection lines SEL1, SEL2, SEL3, and SELm. In the present embodiment, as described above, switching is performed between normal drive for the first display mode and memory drive for the second display mode. A drive method for normal drive, a drive method for when switching from normal drive to memory drive, and a drive method for memory drive will be described in turn below.

### <1.3.1 Drive Method for Normal Drive>

In FIG. 4, normal drive is performed from time point t0 to time point t1. During normal drive, as shown in FIGS. 4A to 4D, an active signal is sequentially provided to each of the gate bus lines GL1 to GLm for a predetermined period of time. Meanwhile, upon normal drive, an active signal is never provided to the memory drive selection lines SEL1 to SELm. Here, looking at a certain pixel (sub-pixel), when an active signal is applied to the gate bus line GL corresponding to the pixel, the switch SW1 goes into an on state. Since upon normal drive an active signal is never provided to the memory drive selection lines, the switch SW2 goes into an off state and the switch SW3 goes into an on state. Accordingly, based on a video signal being applied to the source bus line SL during a period in which the switch SW1 and the switch SW3 are in the on state, a write to the liquid crystal capacitance 51 is performed. In this manner, a write of a video signal to a liquid crystal capacitance 51 is performed on all pixels in one frame period, whereby a desired image is displayed on the display unit 500.

<1.3.2 Drive Method for when Switching from Normal Drive to Memory Drive>

In FIG. 4, during a period from time point t1 to time point t2, drive for switching from normal drive to memory drive is performed. During this period, as shown in FIGS. 4A to 4D, an active signal is sequentially provided to each of the gate bus lines GL1 to GLm for a predetermined period of time and also as shown in FIGS. 4E to 4H, an active signal is sequentially provided to each of the memory dive selection lines SEL1 to SELm for a predetermined period of time. Here, looking at a certain pixel, when an active signal is applied to the gate bus line GL corresponding to the pixel and an active signal is applied to the memory drive selection line SEL corresponding to the pixel, the switch SW1 goes into an on state, the switch SW2 goes into an on state, and the switch SW3 goes into an off state. Accordingly, a video signal being applied to the source bus line SL during a period in which the switch SW1 and the switch SW2 are in the on state is provided to the pixel memory 50, whereby the video signal is stored in the pixel memory 50 as in-memory data MD. In this manner, during the period from time point t1 to time point t2, in-memory data MD is stored in the pixel memories 50 of all pixels. Note that in the following, description is made assuming that when a video signal is binarized (when a video signal is divided into data whose logic level is a high level and data whose logic level is a low level), if the logical level of the video signal is a high level, “1”, is stored in the pixel memory 50 as in-memory data MD, and if the logical level is a low level, “0” is stored in the pixel memory 50 as in-memory data MD.

### <1.3.3 Drive Method for Memory Drive>

In FIG. 4, memory drive is performed from time point t2 to time point t3. Upon memory drive, as shown in FIGS. 4E to 4H, an active signal is provided to all of the memory drive selection lines SEL1 to SELm. Therefore, during a period in which memory drive is performed, the switch SW2 and the switch SW4 are always in an on state and a switch SW3 is always in an off state. Meanwhile, during this period, as shown in FIGS. 4A to 4D, an active signal is never provided to the gate bus lines GL1 to GLm. Hence, during this period, the switch SW1 is always in an off state. As such, since the switch SW1 is in the off state, a value of in-memory data MD is never affected by a video signal supplied through the source bus line SL. In addition, since the switch SW3 is in the off state and the switch SW4 is in the on state, a write to the liquid crystal capacitance 51 is performed based on a voltage signal outputted from the output terminal of the switch SW5 or the output terminal of the switch SW6. Detailed description will be made below using an example.

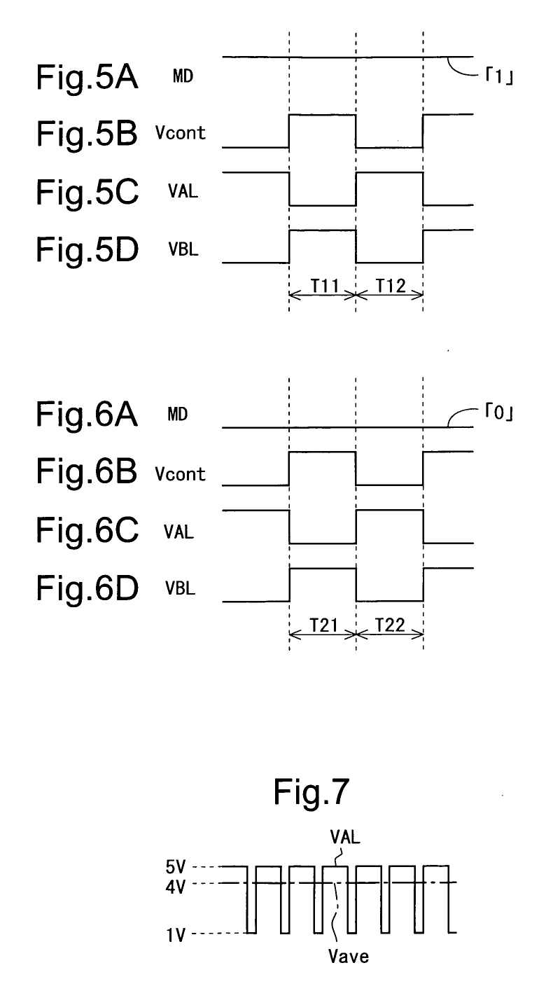

FIG. 5 is a signal waveform diagram for the case in which black display is performed on a pixel in which the value of in-memory data MD is “1” By the way, in order to prevent the deterioration of a liquid crystal due to the application of a direct-current voltage, inversion drive is performed on the common electrode 52 upon both normal dive and memory drive. Specifically, the potential Vcont of the common electrode 52 is switched between a high potential (first potential) and a low potential (second potential) at predetermined intervals.

Looking at the on/off states of the switches SW7 to SW11 in the pixel memory 50, when in-memory data MD is “1”, the switch SW7 goes into an off state and the switch SW8 goes into an on state. Thus, a low potential power supply voltage is provided to the pixel memory 50 from the second power supply line VLCL through the switch SW8. Therefore, the switch SW9 goes into an on state and the switch SW10 goes into an off state. As a result, a high potential power supply voltage is provided to the pixel memory 50 from the first power supply line VLCH through the switch SW9. Since, as described above, upon memory drive, an active signal is never provided to the gate bus lines GL, the switch SW11 is in an on state regardless of the value of in-memory data MD. Accordingly, the value of in-memory data MD is held.

As described above, since a low potential power supply voltage is provided to the pixel memory 50 through the switch SW8, the P-type TFT of the switch SW5 goes into an on state and the N-type TFT of the switch SW6 goes into an off state. On the other hand, since a high potential power supply voltage is provided to the pixel memory 50 through the switch SW9 and the switch SW11 is in the on state, the N-type TFT of the switch SW5 goes into an on state and the P-type TFT of the switch SW6 goes into an off state. Accordingly, the switch SW5 goes into an on state and the switch SW6 goes into an off state. As a result, a voltage (hereinafter, referred to as a “first supply voltage”) VAL provided from the first voltage supply line AL is applied to the pixel electrode 55.

In the present embodiment, as shown in FIGS. 5B and 5C, when the potential Vcont of the common electrode 52 is set to the high potential side (period T11), the potential of the first supply voltage VAL is set to the low potential side, and when the potential Vcont of the common electrode 52 is set to the low potential side (period T12), the potential of the first supply voltage VAL is set to the high potential side. Therefore, a high voltage is always applied to the liquid crystal capacitance 51 and accordingly black display is performed on the pixel.

FIG. 6 is a signal waveform diagram for the case in which white display is performed on a pixel in which the value of in-memory data MD is “0”. Looking at the on/off states of the switches SW7 to SW11 in the pixel memory 50, when in-memory data MD is “0”, the switch SW7 goes into an on state and the switch SW8 goes into an off state. Thus, a high potential power supply voltage is provided to the pixel memory 50 from the first power supply line VLCH through the switch SW7. Therefore, the switch SW9 goes into an off state and the switch SW10 goes into an on state. As a result, a low potential power supply voltage is provided to the pixel memory 50 from the second power supply line VLCL through the switch SW10. Note that the switch SW11 is in an on state, as in the case in which the value of in-memory data MD is “1”. Accordingly, the value of in-memory data MD is held.

As described above, since a high potential power supply voltage is provided to the pixel memory 50 through the switch SW7, the P-type TFT of the switch SW5 goes into an off state and the N-type TFT of the switch SW6 goes into an on state. On the other hand, since a low potential power supply voltage is provided to the pixel memory 50 through the switch SW10 and the switch SW11 is in the on state, the N-type TFT of the switch SW5 goes into an off state and the P-type TFT of the switch SW6 goes into an on state. Therefore, the switch SW5 goes into an off state and the switch SW6 goes into an on state. As a result, a voltage signal (hereinafter, referred to as a “second supply voltage”) provided from the second voltage supply line BL is applied to the pixel electrode 55.

In the present embodiment, as shown in FIGS. 6B and 6D, when the potential Vcont of the common electrode 52 is set to the high potential side (period T21), the potential of the second supply voltage VBL is set to the high potential side, and when the potential Vcont of the common electrode 52 is set to the low potential side (period T22), the potential of the second supply voltage VBL is set to the low potential side. Therefore, a low voltage is always applied to the liquid crystal capacitance 51 and accordingly white display is performed on the pixel.

FIG. 7 is a signal waveform diagram for describing half-tone display in the present embodiment. As described above, when the potential of the first supply voltage VAL and the potential of the second supply voltage VBL are switched in synchronization with timing at which the potential Vcont of the common electrode 52 is inverted, white display or black display is performed. In the present embodiment, by changing a duty ratio (first duty ratio) of the first supply voltage VAL and a duty ratio (second duty ratio) of the second supply voltage VBL, half-tone display is performed. Note that the duty ratio as used in this description refers to the ratio of a period during which a high potential is provided during a certain predetermined period when two potentials, which are a high potential and a low potential, are provided.

For example, with the potential of the high potential side of the first supply voltage VAL being 5V and the potential of the low potential side being 1V, when the duty ratio of the first supply voltage VAL is set to 75 percent, the potential of the first supply voltage VAL changes in the manner shown in FIG. 7 and the average potential Vave thereof is 4V.

In the present embodiment, the duty ratio of the first supply voltage VAL is set by the memory drive control unit 20 in the display control circuit 200. Similarly, the duty ratio of the second supply voltage VBL is also set by the memory drive control unit 20 in the display control circuit 200. Based on those duty ratios, a first supply voltage control signal SAL and a second supply voltage control signal SBL are provided to the memory driver 600 from the memory drive control unit 20. Then, based on the first supply voltage control signal SAL and the second supply voltage control signal SBL, the first supply voltage VAL and the second supply voltage VBL are supplied to the display unit 500 from the memory driver 600.

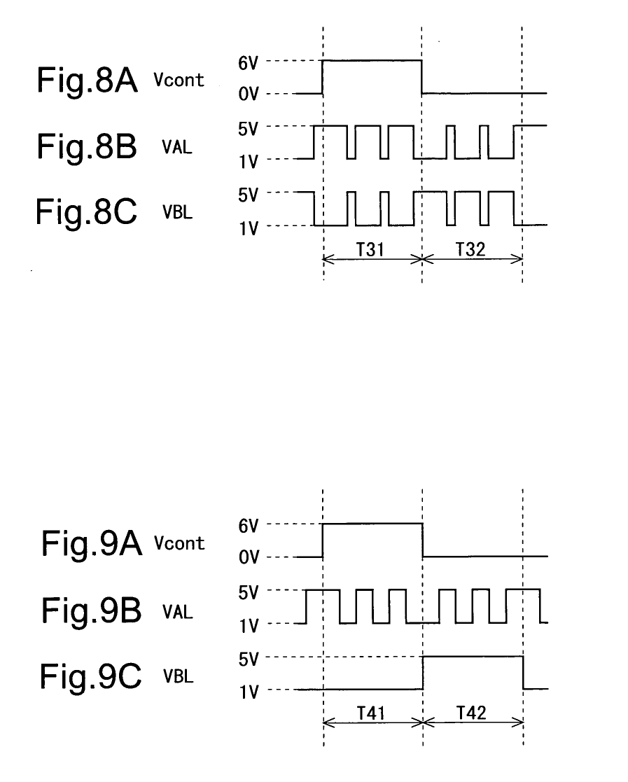

FIG. 8 is a signal waveform diagram showing an example for when half-tone display is performed. In the example, the potential Vcont of the common electrode 52 is switched between 0V and 6V for every predetermined period. The potential of the first supply voltage VAL and the potential of the second supply voltage VBL are switched between 1V and 5V. The duty ratio of the first supply voltage VAL during a period (period T31) in which the potential Vcont of the common electrode 52 is set to 6V is set to 75 percent and the duty ratio of the second supply voltage VBL during such a period is set to 25 percent. Note that the sum of the duty ratio (first value) of the first supply voltage VAL during the period (period T31) in which the potential Vcont of the common electrode 52 is set to 6V and the duty ratio (second value) of the first supply voltage VAL during a period (period T32) in which the potential Vcont of the common electrode 52 is set to 0V is set to 100 percent. The same also applies to the second supply voltage VBL.

As described above, for a pixel in which the value of in-memory data MD is “1”, the first supply voltage VAL is applied to the pixel electrode 55. During the period T31, the average potential of the potential of the first supply voltage VAL is 4V and the potential Vcont of the common electrode 52 is set to 6V. Accordingly, during the period T31, a voltage of 2V is applied to the liquid crystal capacitance 51 of the pixel. During the period T32, the average potential of the potential of the first supply voltage VAL is 2V and the potential Vcont of the common electrode 52 is set to 0V. Accordingly, during the period T32, too, a voltage of 2V is applied to the liquid crystal capacitance 51 of the pixel.

On the other hand, for a pixel in which the value of in-memory data MD is “0”, the second supply voltage VBL is applied to the pixel electrode 55. During the period T31, the average potential of the potential of the second supply voltage VBL is 2V and the potential Vcont of the common electrode 52 is set to 6V. Accordingly, during the period T31, a voltage of 4V is applied to the liquid crystal capacitance 51 of the pixel. During the period T32, the average potential of the potential of the second supply voltage VBL is 4V and the potential Vcont of the common electrode 52 is set to 0V. Accordingly, during the period T32, too, a voltage of 4V is applied to the liquid crystal capacitance 51 of the pixel.

FIG. 9 is a signal waveform diagram showing another Example for when half-tone display is performed. In the example, the potential Vcont of the common electrode 52 is switched between 0V and 6V for every predetermined period. The potential of the first supply voltage VAL and the potential of the second supply voltage VBL are switched between 1V and 5V. The duty ratio of the first supply voltage VAL during a period (period T41) in which the potential Vcont of the common electrode 52 is set to 0V is set to 50 percent and the duty ratio of the second supply voltage VBL during such a period is set to 0 percent.

As described above, for a pixel in which the value of in-memory data MD is “1”, the first supply voltage VAL is applied to the pixel electrode 55. During the period T41, the average potential of the potential of the first supply voltage VAL is 3V and the potential Vcont of the common electrode 52 is set to 6V. Accordingly, during the period T41, a voltage of 3V is applied to the liquid crystal capacitance 51 of the pixel. During a period T42, the average potential of the potential of the first supply voltage VAL is 3V and the potential Vcont of the common electrode 52 is set to 0V. Accordingly, during the period T42, too, a voltage of 3V is applied to the liquid crystal capacitance 51 of the pixel.

On the other hand, for a pixel in which the value of in-memory data MD is “0”, the second supply voltage VBL is applied to the pixel electrode 55. During the period T41, the average potential of the potential of the second supply voltage VBL is 1V and the potential Vcont of the common electrode 52 is set to 6V. Accordingly, during the period T41, a voltage of 5V is applied to the liquid crystal capacitance 51 of the pixel. During the period T42, the average potential of the potential of the second supply voltage VBL is 5V and the potential Vcont of the common electrode 52 is set to 0V. Accordingly, during the period T42, too, a voltage of 5V is applied to the liquid crystal capacitance 51 of the pixel.

As described above, the duty ratios of the first supply voltage VAL and the second supply voltage VBL are set to various values. Meanwhile, as described above, each pixel is configured by three sub-pixels for R, G, and B. As shown in FIG. 3, in the present embodiment, different first voltage supply lines AL (R), AL (G), and AL (B) are respectively connected to the three sub-pixels for R, G, and B. Similarly, different second voltage supply lines BL(R), BL(G), and BL(B) are respectively connected to the three sub-pixels for R, G, and B. That is, different duty ratios for different colors can be set also for the first supply voltage VAL and the second supply voltage VBL. The memory drive control unit 20 can also change the above-described duty ratios during a period in which memory drive is performed. Therefore, multi-gray scale display can also be temporally performed in each pixel.

Looking at the first voltage supply line AL for one color, the first supply voltage VAL of the same duty ratio is supplied to the first to m-th first voltage supply lines AL. Specifically, for example, looking at the first voltage supply line AL (R) for R, the first supply voltage VAL of the same duty ratio is supplied to the first to m-th first voltage supply lines AL. For this regard, the same also applies to first voltage supply lines AL (G) and AL (B) for G and B and the same also applies to the second supply voltage VBL.

### <1.4 Effects>

As described above, according to the present embodiment, in a pixel circuit configuring each sub-pixel, a pixel memory 50 capable of storing 1-bit data is provided. Then, prior to switching to memory drive from normal drive, data for image display for memory drive is stored in the pixel memory 50. While a first supply voltage VAL and a second supply voltage VBL are provided to the pixel circuit, upon memory drive, one of the first supply voltage VAL and the second supply voltage VBL is applied to the pixel electrode 55 according to the value of in-memory data MD stored in the pixel memory 50. Therefore, upon memory drive, there is no need to provide the video signal SL to the pixel circuit. Accordingly, for example, by displaying an image with little change, such as a standby screen of a mobile phone, by memory drive, supplying of a video signal SL having a high frequency becomes unnecessary, reducing power consumption.

Each pixel is configured by three sub-pixels and the duty ratio of the first supply voltage VAL and the duty ratio of the second supply voltage VBL are set on a sub-pixel-by-sub-pixel basis, i.e., on a color-by-color basis. Therefore, voltages of different potentials for different colors can be applied, whereby multi-gray scale image display is implemented. It is also possible to change the duty ratios during a memory drive period. Hence, multi-gray scale image display can be temporally performed.

By setting the above-described duty ratios to various values, the voltage value of the first supply voltage VAL and the voltage value of the second supply voltage VBL become various values. Thus, without increasing the number of voltage supply lines, the number of gray scales of a display image can be increased. Accordingly, the circuit configuration becoming complicated to implement multi-gray scale display does not occur. Furthermore, since the display method of the liquid crystal display device according to the present embodiment is a voltage gray scale method, an event that a display image becomes coarse does not occur, as does in an area ratio gray scale method.

### Second Embodiment

### <2.1 Overall Configuration and Operation of a Liquid Crystal Display Device>

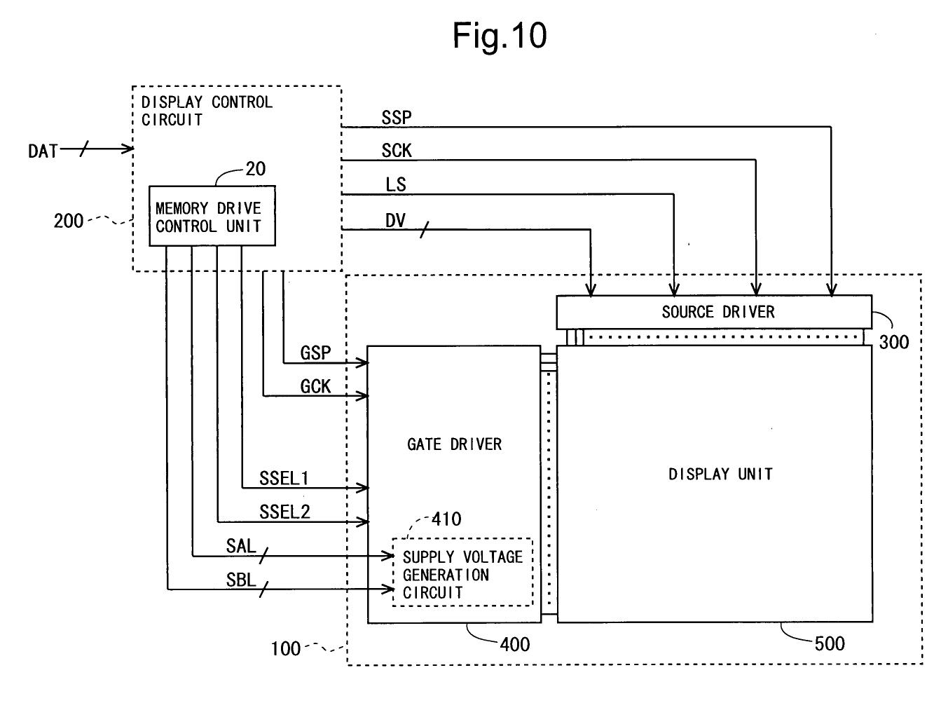

FIG. 10 is a block diagram showing the overall configuration of a liquid crystal display device according to a second embodiment of the present invention. This liquid crystal display device has a liquid crystal display panel 100 and a display control circuit 200. The liquid crystal display panel 100 includes a source driver 300, a gate driver 400, and a display unit 500. The display control circuit 200 includes a memory drive control unit 20 serving as a duty ratio setting circuit. The gate driver 400 includes a supply voltage generation circuit 410. The display unit 500 includes source bus lines, gate bus lines, memory drive selection lines, first voltage supply lines, second voltage supply lines, first power supply lines, and second power supply lines. Note that in the present embodiment the source bus lines are connected to the source driver 300, and the gate bus lines, the memory drive selection lines, the first voltage supply lines, and the second voltage supply lines are connected to the gate driver 400. The display unit 500 also includes a plurality of pixel formation portions respectively provided at intersections of the gate bus lines and the source bus lines. Each pixel formation portion is configured by a pixel electrode serving as a first electrode for applying a voltage according to an image to be displayed to a liquid crystal capacitance; a common electrode serving as a second electrode which is a counter electrode provided so as to be shared between the plurality of pixel formation portions; and a liquid crystal layer provided so as to be shared between the plurality of pixel formation portions and sandwiched between the pixel electrode and the common electrode. If necessary, an auxiliary capacitance is added in parallel to a liquid crystal capacitance which is formed by the pixel electrode and the common electrode. In addition, a pixel memory serving as a storage circuit capable of holding 1-bit data is provided for each pixel formation portion. Note that, as with the above-described first embodiment, the liquid crystal display device according to the present embodiment is of a normally white type, and for a drive method too, switching is performed between “normal drive” for a first display mode and “memory drive” for a second display mode.

The display control circuit 200 receives image data DAT transmitted from an external source and outputs a digital video signal DV, and a source start pulse signal SSP, a source clock signal SCK, a latch strobe signal LS, a gate start pulse signal GSP, a gate clock signal GCK, a first supply voltage control signal SAL, a second supply voltage control signal SBL, a first memory drive control signal SSEL1, and a second memory drive control signal SSEL2 which are used to control image display on the display unit 500.

The source driver 300 receives the digital video signal DV, the source start pulse signal SSP, the source clock signal SCK, and the latch strobe signal LS which are outputted from the display control circuit 200 and applies a drive video signal to each video signal line.

Upon normal drive, the gate driver 400 repeats, in order to sequentially select each gate bus line every one horizontal scanning period, an application of an active scanning signal to each gate bus line with one vertical scanning period as a cycle, based on the gate start pulse signal GSP and the gate clock signal GCK which are outputted from the display control circuit 200. When switching is performed from normal drive to memory drive, the gate driver 400 sequentially applies, in order to sequentially select each gate bus line every one horizontal scanning period, an active signal to each gate bus line based on the gate start pulse signal GSP and the gate clock signal GCK which are outputted from the display control circuit 200, and also sequentially applies, in order to sequentially select each memory drive selection line every one horizontal scanning period, an active signal to each memory drive selection line based on the first memory drive control signal SSEL1 and the gate clock signal GCK which are outputted from the display control circuit 200. Upon memory drive, the supply voltage generation circuit 410 in the gate driver 400 applies a voltage signal to the display unit 500 based on the first supply voltage control signal SAL and the second supply voltage control signal SBL which are outputted from the display control circuit 200.

### <2.2 Configuration of a Pixel Circuit>

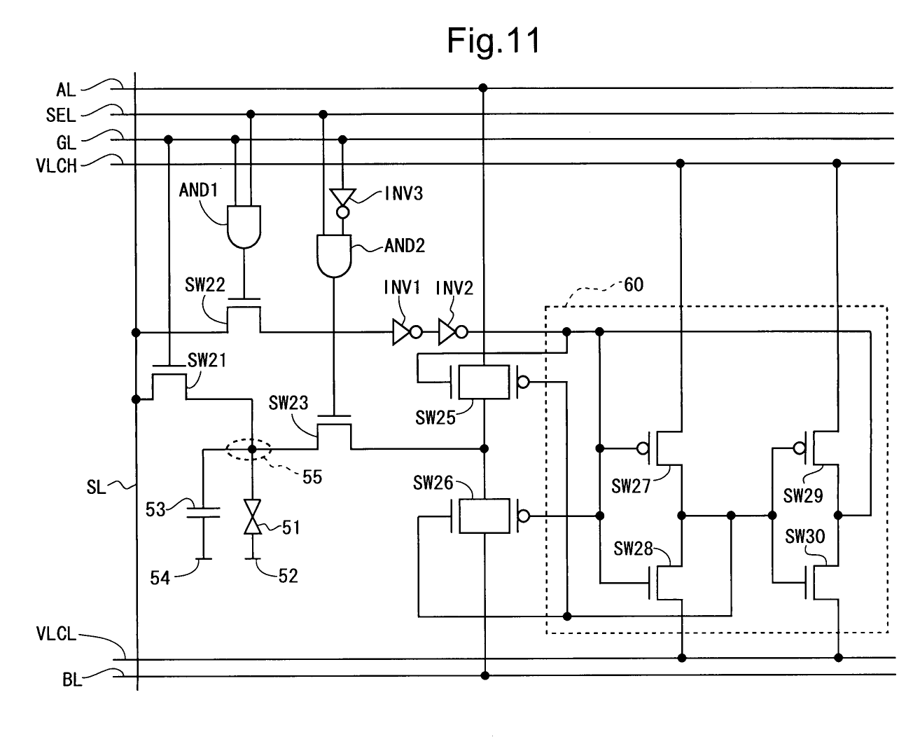

Next, the configuration of a pixel circuit in the present embodiment will be described. FIG. 11 is an equivalent circuit diagram showing the configuration of a pixel circuit of one sub-pixel in the present embodiment. This pixel circuit includes CMOS switches SW25 and SW26, each of which is configured by a P-type TFT and an N-type TFT; switches SW21, SW22, SW23, SW28, and SW30, each of which is implemented by an N-type TFT; switches SW27 and SW29, each of which is implemented by a P-type TFT; inverter circuits INV1, INV2, and INV3; AND operation circuits AND1 and AND2; a liquid crystal capacitance 51; and an auxiliary capacitance 53. In the pixel circuit, a pixel memory 60 is configured by an inverter implemented by the switches SW27 and SW28 and an inverter implemented by the switches SW29 and SW30. In the first embodiment shown in FIG. 1, although the switch SW11 serving as a transfer gate is provided, in the present embodiment, a switch serving as a transfer gate is not provided because the drive capability can be increased by the inverters INV1 and INV2. In addition, in the present embodiment, a selection circuit is implemented by the switches SW25 and SW26. Note that one end of the liquid crystal capacitance 51 and one end of the auxiliary capacitance 53 are connected to a pixel electrode 55. The other end of the liquid crystal capacitance 51 is connected to a common electrode 52 and the other end of the auxiliary capacitance 53 is connected to an auxiliary capacitance electrode 54.

Connection relationships between the switches, etc., are as follows. For the switch SW21, the gate terminal is connected to the gate bus line GL; the source terminal is connected to the source bus line SL; and the drain terminal is connected to the pixel electrode 55. For the switch SW22, the gate terminal is connected to the output terminal of the AND operation circuit AND1; the source terminal is connected to the source bus line SL; and the drain terminal is connected to the input terminal of the inverter circuit INV1. For the switch SW23, the gate terminal is connected to the output terminal of the AND operation circuit AND2; the source terminal is connected to the output terminal of the switch SW25 and the output terminal of the switch SW26; and the drain terminal is connected to the pixel electrode 55.

For the switch SW25, the input terminal is connected to the first voltage supply line AL, the output terminal is connected to the source terminal of the switch SW23 and the output terminal of the switch SW26; the gate terminal of the N-type TFT is connected to the output terminal of the inverter circuit INV2, the gate terminal of the P-type TFT of the switch SW26, the gate terminal of the switch SW27, the gate terminal of the switch SW28, the drain terminal of the switch SW29, and the drain terminal of the switch SW30; and the gate terminal of the P-type TFT is connected to the gate terminal of the N-type TFT of the switch SW26, the drain terminal of the switch SW27, the drain terminal of the switch SW28, the gate terminal of the switch SW29, and the gate terminal of the switch SW30. For the switch SW26, the input terminal is connected to the second voltage supply line BL; the output terminal is connected to the source terminal of the switch SW23 and the output terminal of the switch SW25; the gate terminal of the N-type TFT is connected to the gate terminal of the P-type TFT of the switch SW25, the drain terminal of the switch SW27, the drain terminal of the switch SW28, the gate terminal of the switch SW29, and the gate terminal of the switch SW30; and the gate terminal of the P-type TFT is connected to the output terminal of the inverter circuit INV2, the gate terminal of the N-type TFT of the switch SW25, the gate terminal of the switch SW27, the gate terminal of the switch SW28, the drain terminal of the switch SW29, and the drain terminal of the switch SW30.

For the switch SW27, the gate terminal is connected to the output terminal of the inverter circuit INV2, the gate terminal of the N-type TFT of the switch SW25, the gate terminal of the P-type TFT of the switch SW26, the gate terminal of the switch SW28, the drain terminal of the switch SW29, and the drain terminal of the switch SW30; the source terminal is connected to the first power supply line VLCH; and the drain terminal is connected to the gate terminal of the P-type TFT of the switch SW25, the gate terminal of the N-type TFT of the switch SW26, the drain terminal of the switch SW28, the gate terminal of the switch SW29, and the gate terminal of the switch SW30. For the switch SW28, the gate terminal is connected to the output terminal of the inverter circuit INV2, the gate terminal of the N-type TFT of the switch SW25, the gate terminal of the P-type TFT of the switch SW26, the gate terminal of the switch SW27, the drain terminal of the switch SW29, and the drain terminal of the switch SW30; the source terminal is connected to the second power supply line VLCL; and the drain terminal is connected to the gate terminal of the P-type TFT of the switch SW25, the gate terminal of the N-type TFT of the switch SW26, the drain terminal of the switch SW27, the gate terminal of the switch SW29, and the gate terminal of the switch SW30.

For the switch SW29, the gate terminal is connected to the gate terminal of the P-type TFT of the switch SW25, the gate terminal of the N-type TFT of the switch SW26, the drain terminal of the switch SW27, the drain terminal of the switch SW28, and the gate terminal of the switch SW30; and the source terminal is connected to the first power supply line VLCH; and the drain terminal is connected to the output terminal of the inverter circuit INV2, the gate terminal of the N-type TFT of the switch SW25, the gate terminal of the P-type TFT of the switch SW26, the gate terminal of the switch SW27, the gate terminal of the switch SW28, and the drain terminal of the switch SW30. For the switch SW30, the gate terminal is connected to the gate terminal of the P-type TFT of the switch SW25, the gate terminal of the N-type TFT of the switch SW26, the drain terminal of the switch SW27, the drain terminal of the switch SW28, and the gate terminal of the switch SW29; and the source terminal is connected to the second power supply line VLCL; the drain terminal is connected to the output terminal of the inverter circuit INV2, the gate terminal of the N-type TFT of the switch SW25, the gate terminal of the P-type TFT of the switch SW26, the gate terminal of the switch SW27, the gate terminal of the switch SW28, and the drain terminal of the switch SW29.

For the inverter circuit INV1, the input terminal is connected to the drain terminal of the switch SW22; and the output terminal is connected to the input terminal of the inverter circuit INV2. For the inverter circuit INV2, the input terminal is connected to the output terminal of the inverter circuit INV1; and the output terminal is connected to the gate terminal of the N-type TFT of the switch SW25, the gate terminal of the P-type TFT of the switch SW26, the gate terminal of the switch SW27, the gate terminal of the switch SW28, the drain terminal of the switch SW29, and the drain terminal of the switch SW30. Note that the number of the inverter circuits provided between the switch SW22 and the pixel memory 60 can be increased or decreased if necessary. For the inverter circuit INV3, the input terminal is connected to the gate bus line GL; and the output terminal is connected to a second input terminal of the AND operation circuit AND2. Note that the inverter circuits INV1, INV2, and INV3 respectively output signals obtained by inverting the logic levels of signals provided to the respective input terminals thereof.

For the AND operation circuit AND1, a first input terminal is connected to the gate bus line GL; a second input terminal is connected to the memory drive selection line; and the output terminal is connected to the gate terminal of the switch SW22. For the AND operation circuit AND2, a first input terminal is connected to the memory drive selection line; the second input terminal is connected to the inverter circuit INV3; and the output terminal is connected to the gate terminal of the switch SW23. Note that the AND operation circuits AND1 and AND2 each output, when the logic levels of signals provided to the first input terminal and the second input terminal are both a high level, a signal whose logic level is a high level and otherwise output a signal whose logic level is a low level.

The pixel electrode 55 is connected to the drain terminal of the switch SW21 and the drain terminal of the switch SW23. As described above, the liquid crystal capacitance 51 is formed by the pixel electrode 55 and the common electrode 52 and the auxiliary capacitance 53 is formed by the pixel electrode 55 and the auxiliary capacitance electrode 54.

### <2.3 Drive Method>

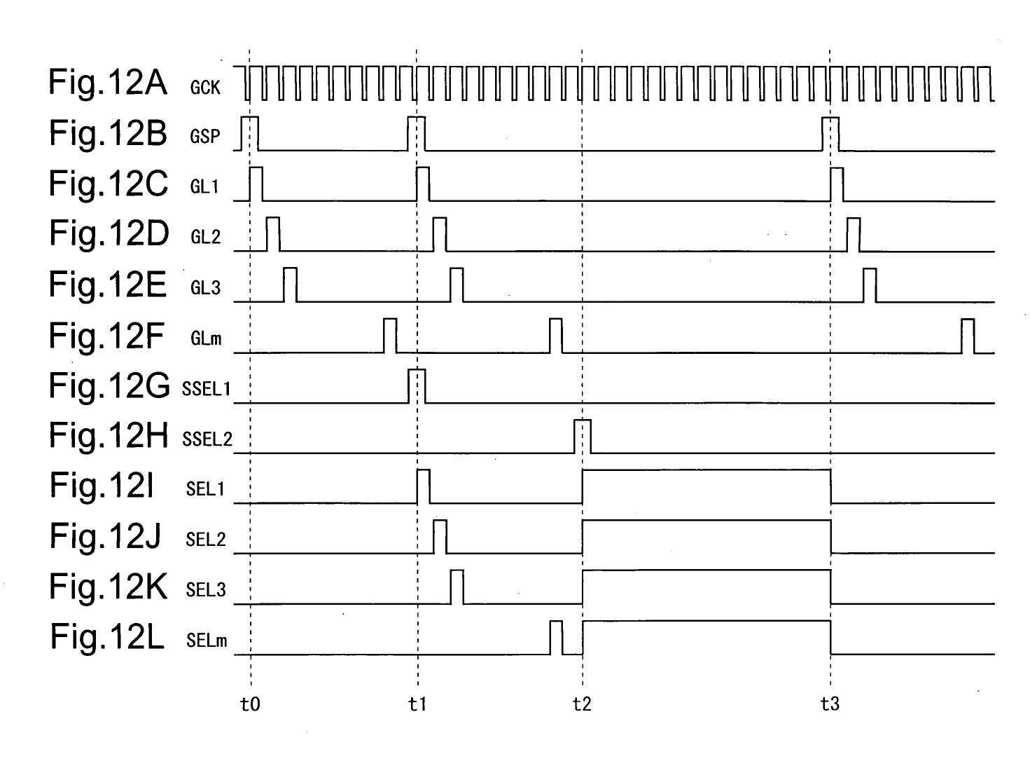

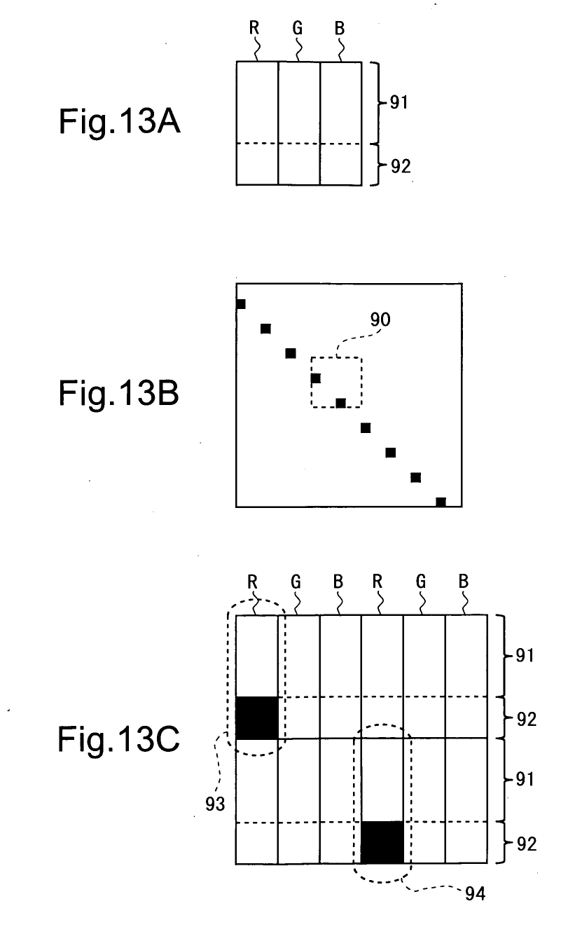

Next, with reference to FIGS. 11 and 12, a drive method in the present embodiment will be described. As with the above-described first embodiment, in the present embodiment, too, switching between normal drive and memory drive is performed. A drive method for normal drive, a drive method for switching from normal drive to memory drive, and a drive method for memory drive will be described in turn below.

### <2.3.1 Drive Method for Normal Drive>

In FIG. 12, normal drive is performed from time point t0 to time point t1. During normal drive, as shown in FIGS. 12C to 12F, an active signal is sequentially provided to each of gate bus lines GL1 to GLm for a predetermined period of time. Meanwhile, upon normal drive, an active signal is never provided to memory drive selection lines SEL1 to SELm. Here, looking at a certain pixel (sub-pixel), when an active signal is applied to the gate bus line GL corresponding to the pixel, the switch SW21 goes into an on state. Since upon normal drive an active signal is never provided to the memory drive selection lines SEL, a high level signal is never outputted from an AND operation circuit AND2. Therefore, the switch SW23 goes into an off state. Accordingly, based on a video signal being applied to the source bus line SL during a period in which the switch SW21 is in the on state and the switch SW23 is in the off state, a write to the liquid crystal capacitance 51 is performed. In this manner, a write of a video signal to the liquid crystal capacitance 51 is performed on all pixels in one frame period, whereby a desired image is displayed on the display unit 500.

<2.3.2 Drive Method for when Switching from Normal Drive to Memory Drive>

In FIG. 12, during a period from time point t1 to time point t2, drive for switching from normal drive to memory drive is performed. During this period, as shown in FIGS. 12C to 12F, an active signal is sequentially provided to each of the gate bus lines GL1 to GLm for a predetermined period of time and also as shown in FIGS. 12I to 12L, an active signal is sequentially provided to each of the memory dive selection lines SEL1 to SELm for a predetermined period of time. Here, looking at a certain pixel, when an active signal is applied to the gate bus line GL corresponding to the pixel and an active signal is applied to the memory drive selection line SEL corresponding to the pixel, the logic level of a signal outputted from the AND operation circuit AND1 is a high level but the logic level. of a signal outputted from the AND operation circuit AND2 is a low level. Therefore, the switch SW22 goes into an on state and the switch SW23 goes into an off state. Accordingly, a video signal being applied to the source bus line SL during a period in which the switch SW22 is in the on state is provided to the input terminal of the inverter circuit INV1. In the inverter circuit INV1, when the voltage value of the video signal is less than or equal to a predetermined threshold value, a high level voltage signal is outputted, and when the voltage value of the video signal is greater than or equal to the predetermined threshold value, a low level voltage signal is outputted. In the inverter circuit INV2, the logic level of the voltage signal outputted from the inverter circuit INV1 is inverted. Then, a value corresponding to the logic level of a voltage signal outputted from the inverter circuit INV2 is stored in the pixel memory 60 as in-memory data MD. In this manner, during the period from time point t1 to time point t2, in-memory data MD is stored in the pixel memories 60 of all pixels. Note that by a gate start pulse signal GSP shown in FIG. 12B and a first memory drive control signal SSEL1 shown in FIG. 12G becoming active, an operation for switching from normal drive to memory drive starts.

### <2.3.3 Drive Method for Memory Drive>

In FIG. 12, memory drive is performed from time point t2 to time point t3. Upon memory drive, as shown in FIGS. 12I to 12L, an active signal is provided to all of the memory drive selection lines SEL1 to SELm. Meanwhile, during a period in which memory drive is performed, as shown in FIGS. 12C to 12F, an active signal is never provided to the gate bus lines GL1 to GLm. Therefore, during this period, the logic level of a signal outputted from the AND operation circuit AND1 is always a low level. As a result, the switch SW22 goes into an off state and thus a value of in-memory data MD is never affected by a video signal supplied through the source bus line SL. In addition, since the switch SW21 is in an off state and the switch SW23 is in an on state, a write to a liquid crystal capacitance 51 is performed based on a voltage signal outputted from the output terminal of the switch SW25 or the output terminal of the switch SW26. Note that by the second memory drive control signal SSEL2 shown in FIG. 12H becoming active, memory drive starts.

When the value of in-memory data MD is “1”, a pixel circuit operates in the manner described below. Looking at the on/off states of the switches SW27 to SW30 in the pixel memory 60, the switch SW27 goes into an off state and the switch SW28 goes into an on state. Thus, a low potential power supply voltage is provided to the pixel memory 60 from the second power supply line VLCL through the switch SW28. Accordingly, the switch SW29 goes into an on state and the switch SW30 goes into an off state. As a result, a high potential power supply voltage is provided to the pixel memory 60 from the first power supply line VLCH through the switch SW29.

As described above, since a low potential power supply voltage is provided to the pixel memory 60 through the switch SW28, the P-type TFT of the switch SW25 goes into an on state and the N-type TFT of the switch SW26 goes into an off state. On the other hand, since a high potential power supply voltage is provided to the pixel memory 60 through the switch SW29, the N-type TFT of the switch SW25 goes into an on state and the P-type TFT of the switch SW26 goes into an off state. Accordingly, the switch SW25 goes into an on state and the switch SW26 goes into an off state. As a result, a voltage signal (first supply voltage) VAL provided from the first voltage supply line AL is applied to the pixel electrode 55.

When the value of in-memory data MD is “0”, a pixel circuit operates in the manner described below. Looking at the on/off states of the switches SW27 to SW30 in the pixel memory 60, the switch SW27 goes into an on state and the switch SW28 goes into an off state. Thus, a high potential power supply voltage is provided to the pixel memory 60 from the first power supply line VLCH through the switch SW27. Accordingly, the switch SW29 goes into an off state and the switch SW30 goes into an on state. As a result, a low potential power supply voltage is provided to the pixel memory 60 from the second power supply line VLCL through the switch SW30.

As described above, since a high potential power supply voltage is provided to the pixel memory 60 through the switch SW27, the P-type TFT of the switch SW25 goes into an off state and the N-type TFT of the switch SW26 goes into an on state. On the other hand, since a low potential power supply voltage is provided to the pixel memory 60 through the switch SW30, the N-type TFT of the switch SW25 goes into an off state and the P-type TFT of the switch SW26 goes into an on state. Accordingly, the switch SW25 goes into an off state and the switch SW26 goes into an on state. As a result, a voltage signal (second supply voltage) VBL provided from the second voltage supply line BL is applied to the pixel electrode 55.

In the above-described manner, upon memory drive, a first supply voltage VAL or a second supply voltage VBL is applied to the pixel electrode 55 according to the value of in-memory data MD. At this time, the duty ratio of the first supply voltage VAL is based on the first supply voltage control signal SAL and the duty ratio of the second supply voltage VBL is based on the second supply voltage control signal SBL. These duty ratios can be set to different values for different colors, as in the above-described first embodiment, and can be temporally changed. Note that the details of black display, white display, and half-tone display for memory drive are the same as those in the above-described first embodiment and thus description thereof is omitted.

### <2.4 Effects>

As described, as with the above-described first embodiment, in the present embodiment, too, in a pixel circuit configuring each sub-pixel, a pixel memory 60 capable of storing 1-bit data is provided. Upon memory drive, one of the first supply voltage VAL and the second supply voltage VBL is applied to the pixel electrode 55 according to the value of in-memory data MD stored in the pixel memory 60. Hence, by displaying an image with little change by memory drive, a video signal having a high frequency becomes unnecessary, reducing power consumption. In addition, the duty ratios of the first supply voltage VAL and the second supply voltage VBL can be set to various values for different colors and can also be temporally changed. Accordingly, a display device capable of performing multi-gray scale image display is implemented without complicating the circuit configuration.

### <3. Others>

Although in the above-described first and second embodiments description is made assuming that the device is a normally white type liquid crystal display device, the present invention is not limited thereto and the present invention can also be applied to a normally black type liquid crystal display device. Also, although description is made using, as an example, a liquid crystal display device as a display device, the present invention is not limited thereto and the present invention can be applied also to other display devices as long as the display device is one adopting a voltage gray scale method.

Furthermore, although the first voltage supply lines AL and the second voltage supply lines BL in the display unit 500 are connected to the memory driver 600 in the above-described first embodiment and are connected to the gate driver 400 in the above-described second embodiment, the present invention is not limited thereto. For example, they may be connected to the source driver 300 or may be connected to the display control circuit 200 if the present invention is applied only to a partial area in the display unit 500.

1. A display device having a first display mode and a second display mode, the display device comprising:
a plurality of video signal lines for transmitting a video signal which is based on an image to be displayed;
a plurality of scanning signal lines intersecting the plurality of video signal lines;
a plurality of pixel formation portions arranged in a matrix so as to correspond to intersections of the plurality of video signal lines and the plurality of scanning signal lines, each pixel formation portion including a first electrode and a second electrode which sandwich a display medium for forming the image to be displayed;
a plurality of storage circuits provided for the respective plurality of pixel formation portions, each storage circuit capturing and storing binary data which is based on the video signal transmitted by a video signal line passing through a corresponding intersection, when switching is performed from the first display mode to the second display mode;
a duty ratio setting circuit that sets a first duty ratio and a second duty ratio according to the image to be displayed;
a supply voltage generation circuit that generates a first supply voltage having a pulse width which is based on the first duty ratio and a second supply voltage having a pulse width which is based on the second duty ratio;
a plurality of first voltage supply lines provided for the respective plurality of scanning signal lines and transmitting the first supply voltage;
a plurality of second voltage supply lines provided for the respective plurality of scanning signal lines and transmitting the second supply voltage; and
a plurality of selection circuits provided for the respective plurality of pixel formation portions, each selection circuit applying, in the second display mode, one of the first supply voltage and the second supply voltage to the first electrode provided in a corresponding pixel formation portion, according to a value of the binary data stored in a corresponding storage circuit, the first supply voltage being transmitted by the first voltage supply line provided for a scanning signal line passing through a corresponding intersection and the second supply voltage being transmitted by the second voltage supply line provided for the scanning signal line passing through the corresponding intersection.

2. The display device according to claim 1, wherein
the first voltage supply lines include first voltage supply lines for a first color, a second color, and a third color,
the second voltage supply lines include second voltage supply lines for the first color, the second color, and the third color, and
the duty ratio setting circuit
sets the first duty ratio for each of the first voltage supply lines for the first color, the second color, and the third color, and
sets the second duty ratio for each of the second voltage supply lines for the first color, the second color, and the third color.

3. The display device according to claim 1, wherein the duty ratio setting circuit temporally changes the first duty ratio and the second duty ratio according to the image to be displayed.

4. The display device according to claim 1, wherein
a predetermined first potential and a predetermined second potential are alternately provided to the second electrodes at predetermined intervals, and
the duty ratio setting circuit
changes the first duty ratio such that a first value and a second value whose sum is 100% are alternately set at the predetermined intervals as the first duty ratio, and
changes the second duty ratio such that a third value and a fourth value whose sum is 100% are alternately set at the predetermined intervals as the second duty ratio.

5. A drive method for a display device having a first display mode and a second display mode, the display device including: a plurality of video signal lines for transmitting a video signal which is based on an image to be displayed; a plurality of scanning signal lines intersecting the plurality of video signal lines; a plurality of pixel formation portions arranged in a matrix so as to correspond to intersections of the plurality of video signal lines and the plurality of scanning signal lines, each pixel formation portion including a first electrode and a second electrode which sandwich a display medium for forming the image to be displayed; a plurality of storage circuits provided for the respective plurality of pixel formation portions; a plurality of first voltage supply lines provided for the respective plurality of scanning signal lines; a plurality of second voltage supply lines provided for the respective plurality of scanning signal lines; and a supply voltage generation circuit that generates a first supply voltage to be applied to the plurality of first voltage supply lines and a second supply voltage to be applied to the plurality of second voltage supply lines, the drive method comprising:
a display mode switching step of switching from the first display mode to the second display mode by capturing and storing, in each storage circuit, binary data which is based on the video signal transmitted by a video signal line passing through a corresponding intersection;
a duty ratio setting step of setting a first duty ratio for setting a pulse width of the first supply voltage and a second duty ratio for setting a pulse width of the second supply voltage, based on the image to be displayed; and
a second display mode displaying step of applying, in each pixel formation portion, one of the first supply voltage and the second supply voltage to the corresponding first electrode, according to a value of the binary data stored in a corresponding storage circuit, the first supply voltage being transmitted by the first voltage supply line provided for a scanning signal line passing through a corresponding intersection and having a pulse width which is based on the first duty ratio, and the second supply voltage being transmitted by the second voltage supply line provided for the scanning signal line passing through the corresponding intersection and having a pulse width which is based on the second duty ratio.

6. The drive method according to claim 5, wherein in the duty ratio setting step, the first duty ratio and the second duty ratio are temporally changed according to the image to be displayed.

7. The drive method according to claim 5, wherein
a predetermined first potential and a predetermined second potential are alternately provided to the second electrodes at predetermined intervals, and
in the duty ratio setting step,
the first duty ratio is changed such that a first value and a second value whose sum is 100% are alternately set at the predetermined intervals as the first duty ratio, and
the second duty ratio is changed such that a third value and a fourth value whose sum is 100% are alternately set at the predetermined intervals as the second duty ratio.
